(19) United States
(12) Patent Application Publication
(10) Pub. No.: US 2020/0349827 A1
(43) Pub. Date: Nov. 5, 2020

(54) rEXIT

(71) Applicants: Meghana R. Joshi, Irivne, CA (US); Rajesh S. Joshi, Irivne, CA (US)

(72) Inventors: Meghana R. Joshi, Irivne, CA (US); Rajesh S. Joshi, Irivne, CA (US)

(21) Appl. No.: 16/400,024

(22) Filed: Apr. 30, 2019

(51) Int. Cl. G08B 25/00; G08B 7/06; G09F 13/04

(52) U.S. Cl. CPC G08B 25/009; G08B 7/066; G09F 2013/0459; G09F 13/04; G08B 7/062

(57) ABSTRACT

An emergency monitoring and, communication system comprises a plurality of exit devices located throughout a building and each locally capable of ascertaining an emergency event in vicinity of its location. The exit devices communicate their locations and emergency events. Each of the plurality of exit devices is equipped with an emergency sensor, a location sensor, a communication module, and a controller. A display screen and a speaker may be included in the exit device to be utilized for providing visual and audible signals, respectively. Each exit devise is, capable of receiving the location coordinates from the other exit devices in the system, ascertaining at least one of a safe pathway and an unsafe pathway, and further communicating them to a hand-held device to be displayed utilizing a programing application included in the hand-held device.

### COPYRIGHT

A portion of the disclosure of this patent document contains material which is subject to copyright protection. The owner has no objection to the facsimile reproduction by anyone of the patent disclosure, as it appears in the Patent and Trademark Office files or records, but otherwise reserves all copyright rights whatsoever.

### FIELD OF INVENTION

The present invention relates to an exit device, an emergency monitoring and communication system comprising a plurality of said exit devices for a building and method of operation. In particular, the exit devices are located throughout the building and each locally ascertains an emergency event in vicinity of its location. They further operate to communicate their respective location coordinates in response to their respective emergency events. The exit device is equipped with an emergency sensor, a location sensor, a communication module, and a controller. The exit device may further comprise a display screen and a speaker to provide visual/visible and audible signals. The exit device may receive location coordinates from the other exit devices in the system, ascertain at least one of a safe pathway and an unsafe pathway, and further communicate it to a hand-held device.

### BACKGROUND

Fire alarm systems are utilized in buildings to detect and warn people of emergency events, including man-made emergency events. Natural emergency events Such emergency events include, but are not limited to, the presence of fire, smoke, and/or carbon monoxide mass-shootings in the building. Throughout the United States and in many other foreign jurisdictions, building owners and/or operators are required by law to install fire alarm systems to ascertain and notify the presence of an emergency event affecting the building and threatening the safety of its occupants.

Conventional fire alarm systems include a number of devices that operate together to detect and issue warning signals. A fire alarm system ordinarily includes a smoke detector, a fire detector, a carbon monoxide detector, a flame detector, or a combination of these emergency event sensors to detect the emergency event. They also include exit signs and speakers to provide visible/visual and audible signals in response to the emergency event.

Conventional exit signs are passive components that are turned on by the fire alarm system to display and warn people of the emergency event. They lack the capability of detecting localized emergency events, such as localized fire, and communicating their locations within the system and coordinating safe exiting.

With conventional fire alarm systems, occupants cannot be warned of localized emergency events. For instance, in a typical fire emergency event, a conventional fire alarm system turns on all exit signs directing the occupants to two or more exit ports. However, if there is fire behind one or more of those exit ports, the occupants will nevertheless be directed to those harmful locations. Therefore, there is a need for an exit device that is capable of detecting localized emergency events and communicating them so as to warn the occupants of such harmful exit ports, Moreover, with conventional emergency monitoring systems, occupants cannot be safely directed during an event of man-made emergencies like mass shooting or localized emergencies within the building. Therefore, there is a need for an exit device that is capable of coordinating exit post safety via instructions.

### SUMMARY

In one aspect, an emergency monitoring and communication system for a building is disclosed wherein said building comprising a plurality of exit devices located throughout the building and wherein each of said plurality of exit devices is configured to ascertain an emergency event in vicinity of its location and to transmit a location signal in response to the emergency event.

Preferably, each of said plurality of exit devices is further configured to transmit a status signal in response to the emergency event.

Preferably, the status signal is one of safe-status and unsafe-status.

Preferably, each of said plurality of exit devices is further configured to display a visual signal in response to the emergency event.

Preferably, the visual signal is one of red-color arrow sign and green-color arrow sign.

Preferably, each of said plurality of exit devices is further configured to broadcast an audible signal in response to the emergency event.

Preferably, the audible signal is a voice speaking one of come-toward and go-away.

Preferably, the emergency event is ascertained when at least one of flame, heat, carbon monoxide, and smoke is detected.

Preferably, each of said plurality of exit devices is further configured to store its location in its storage device.

Preferably, each of said plurality of exit devices is further configured to receive one or more location signals from one or more of said plurality of exit devices and to ascertain at least one of a safe pathway and an unsafe pathway.

Preferably, the safe pathway is a pathway which does not include any exit device that has transmitted a location signal in response to the emergency event in vicinity of its location and wherein the unsafe pathway is a pathway which includes at least one exit device that has transmitted a location signal in response to the emergency event in, vicinity of its location.

Preferably, the system further comprises a hand-held device, said hand-held device comprising an application program configured to display the at least one of a safe pathway and an unsafe pathway.

Preferably, said building further comprises two or more exit ports and wherein two or more of said plurality of exit devices are located in vicinity of the two or more exit ports.

In another aspect, an exit device is disclosed wherein the exit device comprises an emergency sensor operative to detect an emergency event and to generate an emergency signal in response to the emergency event, a location sensor operative to detect its location and to generate a location signal, a communication module operative to at least one of receive and transmit radio waves, and a controller, including a processing unit and program code stored on a storage device of said controller, said controller is coupled with the emergency sensor, the location sensor, and the communication module, and wherein the controller is configured to receive the emergency signal, via the emergency sensor, the location signal, via the location sensor, and to transmit the location signal, via the communication module, in response to the emergency signal.

Preferably, the controller is further configured to transmit a status signal, via the communication module, in response to the emergency signal.

Preferably, the status signal is one of safe-status and unsafe-status.

Preferably, the exit device further comprises a display screen coupled with the controller, wherein the controller is further configured, to display a visual signal, via the display screen, in response to the emergency signal.

Preferably, the visual signal is one of red-color arrow sign and green-color arrow sign.

Preferably, the exit device further comprises a speaker coupled with the controller, wherein the controller is further configured to broadcast an audible signal, via the speaker, in response to the emergency signal.

Preferably, the audible signal is a voice speaking one of come-toward and go-away.

Preferably, the emergency sensor is one of a flame detector, a heat detector, a carbon monoxide detector, and a smoke detector.

Preferably, the controller is further configured to receive one or More location signals from one or more exit devices, via the communication module, and to determine at least one of a safe pathway and an unsafe pathway.

Preferably, the safe pathway is a pathway which does not include any exit device that has transmitted a location signal in response to the emergency event in vicinity of its location and wherein the unsafe pathway is a pathway which includes at least one exit device that has transmitted a location signal in response to the emergency event in vicinity of its location.

In another aspect, a method of monitoring and communicating an emergency event, via an exit device is disclosed wherein said exit device comprises an emergency sensor, a location sensor, a communication module, and a controller, said method comprising detecting the emergency event, via the emergency sensor, generating an emergency signal in response to the emergency event, via the emergency sensor, detecting a location of the exit device, via the location sensor, generating a location signal, via the location sensor, receiving the emergency signal, via the controller, receiving the location signal, via the controller, and transmitting the location signal, via the communication module, in response to the emergency signal.

Preferably, the method further comprises transmitting a status signal, via the communication module, in response to the emergency signal.

Preferably, the exit device further comprises a display screen and the method further comprises displaying a visual signal, via the display screen, in response to the emergency signal.

Preferably, the exit device further comprises a speaker and the method further comprises broadcasting an audible signal, via the speaker, in response to the emergency signal.

Preferably, the method further comprises receiving one or more location signals from one or more exit devices, via the communication module and determining at least one of a safe pathway and an unsafe pathway, via the controller.

### DESCRIPTION OF THE DRAWINGS

FIG. 1 shows a front perspective view of a multi-story building having an emergency monitoring and communication system operable to detect localized fire and transmit their coordinates to better warn the building's occupants.

FIG. 2 shows a front perspective view and a partial cutaway view of two levels with occupants of a multi-story building having an emergency monitoring and communication system operable to detect localized fire and transmit their coordinates to better warn the occupants.

FIG. 3 shows a partial cutaway view of a floor of a building having an emergency monitoring and communication system comprising two exit devices according to a preferred embodiment of the present invention.

FIG. 4 shows a partial cutaway view of a floor of a building having an emergency monitoring and communication system comprising two exit devices and a hand-held device utilized by an occupant according to a preferred embodiment of the present invention.

FIG. 5 shows a block diagram of an exit device comprising a controller, a flame detector, a location sensor, a communication module, a display screen, and a speaker according to a preferred embodiment of the present invention.

FIG. 6A is a flow diagram of one preferred method of monitoring and communicating an emergency event, via an exit device such as the one depicted in FIG. 5, to detect and transmit the location of the localized emergency event.

FIG. 6B is a flow diagram of one preferred method of monitoring and communicating an emergency event, via an exit device such as the one depicted in FIG. 5, which is similar to FIG. 6A, further outputting additional warning signals and receiving location signals from other exit devices within the system to arrive at a safe pathway for the occupants to safely exit the building.

### DETAILED DESCRIPTION OF THE PRESENTLY PREFERRED EMBODIMENTS

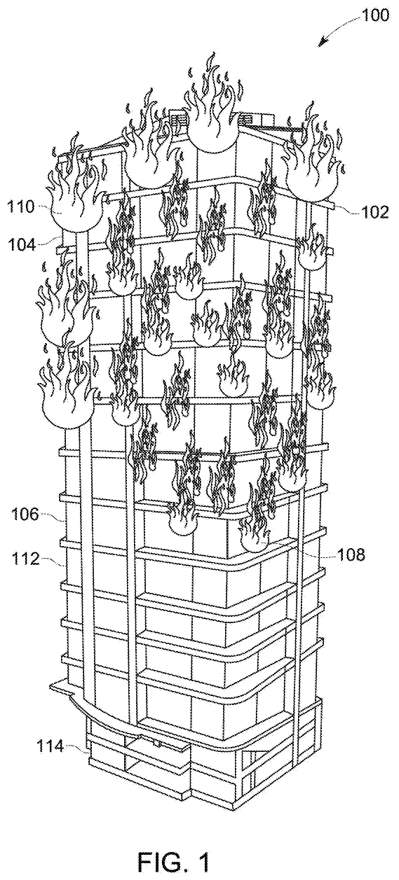

FIG. 1 depicts a front perspective view 100 of a multi-story building 102 having an emergency monitoring and communication system (not shown). The system comprises a plurality of exit devices (not shown) throughout the building 102. In one preferred embodiment, the exit devices are mounted on the walls of the building 102. In an alternative embodiment, the exit devices are mounted on the ceilings of building 102. Several floors of the building 102, such as floors 104 and 106, are on fire which is localized, such as localized fires 108 and 110. Several other floors, such as floors 112 and 114, are safe and the emergency monitoring and communication system will direct the occupants of the building 102 to the safe floors 112 and 114 to eventually escape from the building 102.

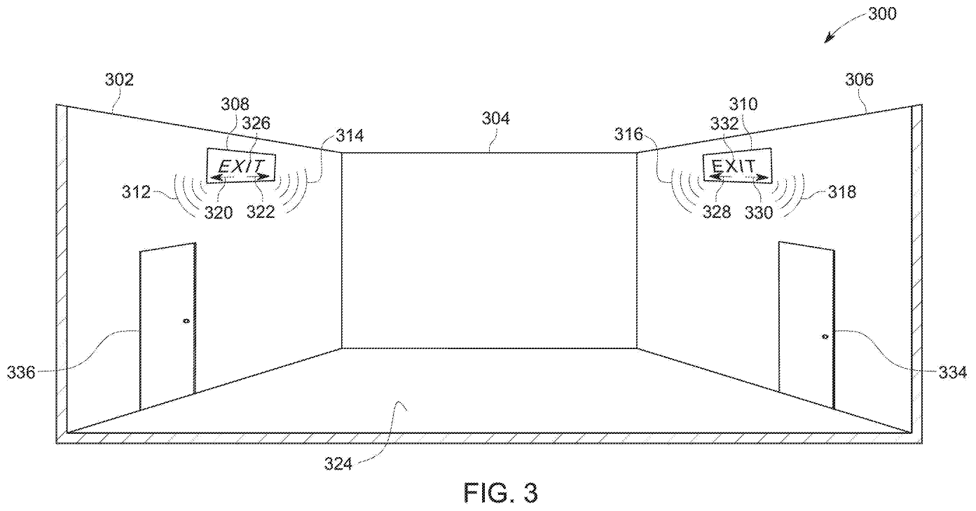

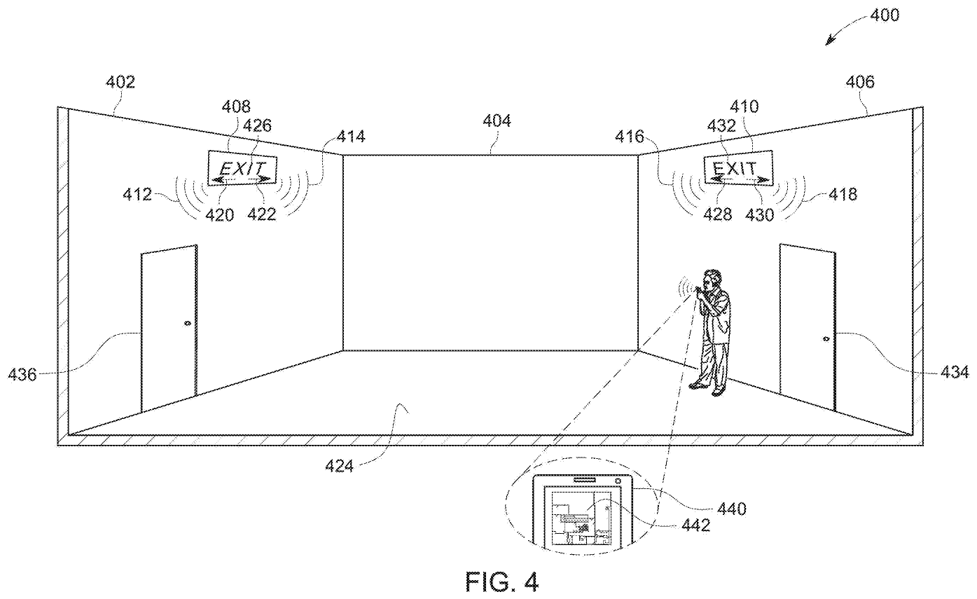

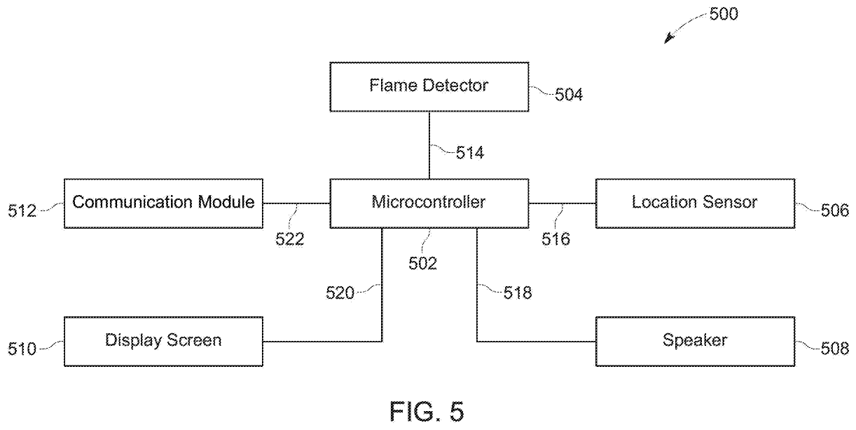

Each floor of the building 102, such as the floors 104, 106, 112, and 114 are designed to be connected through stairs (not shown). In case of an emergency, such as a fire, the occupants will be directed to these stairs to exit the building 102. There are two or more exit ports, such as those shown in FIG. 3 and FIG. 4, on each floor, such as the floors 104, 106, 112, and 114. A plurality of exit devices (shown in FIG. 5) are included in the emergency monitoring and communication system. Each exit device is capable of detecting a localized emergency event, such as the localized fires 108 and 110, and communicating the locations of the localized emergency events.

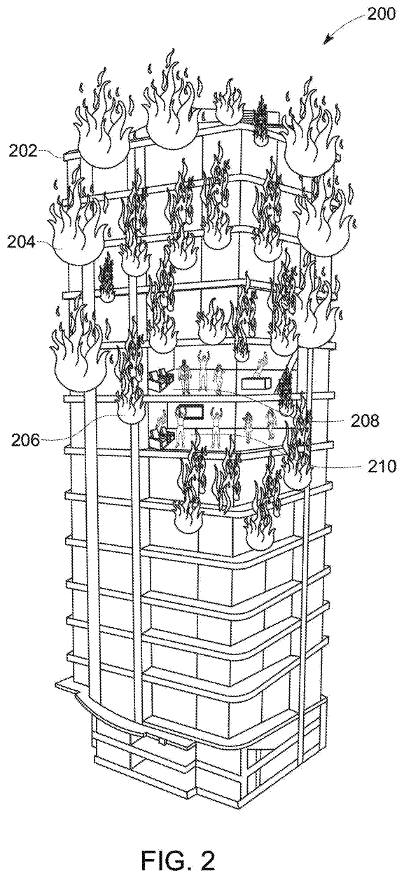

FIG. 2 depicts a front perspective view and a partial cutaway view 200 of two levels 208 and 210 with occupants of a multi-story building 202 having an emergency monitoring and communication system (not shown). Similar to FIG. 1, the system includes a plurality of exit devices (not shown) throughout the building 202 operable to detect localized fires 204 and 206 and transmit their coordinates to one another. Each exit device is capable of determining a safe pathway by having the coordinates of the localized fires, such as the localized fires 204 and 206. In a preferred embodiment, the system includes one or more hand-held devices and the exit devices communicate the safe pathway with the hand-held device.

Whereas in conventional alarm systems the entire building 202 is on a general warning state throughout the building 202 regardless of the locations of the emergency events, the emergency monitoring and communication system operates to sense localized emergency events so as to issue more informative warning signals to the occupants of the building 202. An emergency event is not limited to fire but can be smoke or carbon monoxide.

FIG. 3 depicts a partial cutaway view 300 of a floor 324 of a building, such as the buildings shown in FIG. 1 and FIG. 2, having an emergency monitoring and communication system comprising two exit devices 308 and 310 mounted on walls 302 and 306 in vicinity of two exit ports 336 and 334, according to a preferred embodiment of the present invention. The exit device 308 includes an emergency sensor (not shown) which operates to detect an emergency event in vicinity of its location and to generate an emergency signal in response to the emergency event. It further includes a location sensor (not shown) which functions to detect its location and to generate a location signal. A communication module (not shown), included in the exit device 308, is capable of receiving and transmitting radio waves 314. A controller (not shown) which includes a processing unit and program code stored on a storage device of said controller is electrically connected with the emergency sensor, the location sensor, and the communication module.

The controller is configured to receive the emergency signal, via the emergency sensor, the location signal, via the location sensor, and to transmit the location signal, via the communication module, in response to the emergency signal. The exit device 308 further includes a display screen 326, coupled with the controller, displaying the word “EXIT” and two arrow signs 320 and 322 which are facing in the opposite directions. The word “EXIT” and the arrow signs 320 and 322 are pursuant to the current and relevant applicable building codes. The arrow sign 320 maybe displayed in red color or green color depending on the emergency signal. Similarly, the arrow sign 322 maybe displayed in red color or green color depending on the emergency signal. The exit device 308 further includes a speaker (not shown), coupled with the controller, broadcasting sound waves 312 which can be heard by the occupants.

Similarly, the exit device 310 includes an emergency sensor (not shown) detecting an emergency event in vicinity of its location and generating an emergency signal in response to the emergency event. A location sensor (not shown) included in the exit device 310 detects its location and generates a location signal. The exit device 310 further includes a communication module (not shown) which receives and transmits radio waves 318, through WIFI connection, Bluetooth connection, or through networks such as the Internet. A controller (not shown) which includes a processing unit and program code stored on a storage device of said controller is similarly coupled with the emergency sensor, the location sensor, and the communication module.

The controller is configured to receive the emergency signal, via the emergency sensor, the location signal, via the location sensor, and to transmit the location signal, via the communication module, in response to the emergency signal. A display screen 332 is included in the exit device 310 and is electrically connected to the controller. It displays the word “EXIT” and two arrow signs 328 and 330 pointing to opposite directions. The arrow sign 328 maybe displayed in red color or green color depending on the emergency signal. Similarly, the arrow sign 330 maybe displayed in red color or green color depending on the emergency signal. A speaker (not shown) is also included in the exit device 310 which is also coupled with the controller. It broadcasts audible signals, i.e., sound waves 316.

FIG. 4 depicts a partial cutaway view 400 of a floor 424 of a building, such as the buildings shown in FIG. 1 and FIG. 2, having an emergency monitoring and communication system comprising two exit devices 408 and 410 mounted on walls 402 and 406 in vicinity of two exit ports 436 and 434. The system further comprises a hand-held device 440 utilized by an occupant 438 according to a preferred embodiment of the present invention. The hand-held device 440 maybe a laptop, a mobile device such as an iPhone, or a wearable such as an Apple Watch. The hand-held device 440 comprises an application program (App) 442 that is configured to display at least one of a safe pathway and an unsafe pathway.

The exit device 408 includes a flame detector (not shown) which operates to detect fire in vicinity of its location and to generate a fire signal in response to the fire. It further includes a GPS (global positioning system, not shown) which functions to detect the exit device 408 and to generate a location signal. A WIFI module (not shown), included in the exit device 408, is capable of receiving and transmitting radio waves 414 to allow a controller (not shown) included in the exit device 408 to communicate with the building's WIFI network. The controller which includes a processing unit and program code stored on a storage device of said controller is electrically connected with the fire detector, the GPS, and the WIFI module.

The controller is configured to receive the fire signal, via the fire detector, the location signal, via the GPS, and to transmit the location signal, via the WIFI module, in response to the fire signal. The exit device 408 further includes a display screen 426, coupled With the controller, displaying the word “EXIT” and two arrow signs 420 and 422 which are facing in the opposite directions. The arrow sign 420 maybe displayed in red color or green color depending on, the emergency signal. Similarly, the arrow sign 422 maybe displayed in red color or green color depending on the fire signal. The exit device 408 further includes a speaker (not shown), coupled with the controller, broadcasting sound waves 412 which can be heard by the occupants.

The exit device 410 includes a smoke detector (not shown) detecting smoke in vicinity of its location and generating a smoke signal in response to the smoke. A GPS (not shown) included in the exit device 410 detects its location and generates a location signal. The exit device 410 further includes a Bluetooth module (not shown) which receives and transmits radio waves 418, through Bluetooth connection. A controller (not shown) which includes a processing unit and program code stored on a storage device of said controller is similarly coupled with the smoke detector, the GPS, and the Bluetooth module.

The controller is configured to receive the smoke signal, via the smoke detector, the location signal, via the GPS, and to transmit the location signal, via the Bluetooth module, in response to the smoke signal. A display screen 432 is included in the exit device 410 and is electrically connected to the controller. It displays the word “EXIT” and two arrow signs 428 and 430 pointing to opposite directions. The arrow sign 428 maybe displayed in red color or green color depending on the emergency signal. Similarly, the arrow sign 430 maybe displayed in red color or green color depending on the emergency signal. A speaker (not shown) is also included in the exit device 410 which is also coupled with the controller. It broadcasts audible signals, i.e., sound waves 416.

FIG. 5 depicts a block diagram of an exit device 500 comprising a controller 502, a flame detector 504, a location sensor 506, a communication module 512, a display screen 510, and a speaker 508 according to a preferred embodiment of the present invention. The controller 502 is connected to and in, communication with the flame detector 504 via a sense line 514. The controller 502 is further connected to and in communication with the location sensor 506 via a sense line 516. The controller 502 is connected to and in communication with the communication module 512 via a receive/transmit line 522. The controller 502 is further connected to and in communication with the display screen 510 via a control line 520. The controller 502 is also connected to and in communication with the speaker 508 via a control line 518. The exit device 500 is electrically powered by the building's electrical power system which may comprise an Uninterrupted Power Supply (UPS). Accordingly, the controller 502, the flame detector 504, the location sensor 506, the communication module 512, the display screen 510, and the speaker 508 receive their electrical power from the building's electrical power system.

The controller 502 maybe analog or digital such as includes a microcontroller. In one preferred embodiment, the microcontroller is a 68HC08 processor having internal flash memory available from Freescale of Austin, Tex. It is contemplated that the processor may be a combination of individual discrete or separate integrated circuits packaged in a single housing or it may be fabricated in a single integrated circuit. The communication module 512 maybe the ESP8266 Module available from SparkFun Electronics of Niwot of Colorado. The communication module 512 may alternatively be the HC-05 Bluetooth Module also available from SparkFun Electronics of Niwot of Colorado. The flame detector 504 maybe the FL500 UV/IR Flame Detector available from Cranberry Township of Pennsylvania. The speaker 508 and the display screen 510 are available from Amazon.com.

The controller 502 is configured to sense a flame signal from the flame detector 504 via the sense line 514, to sense a location signal from the location sensor 506 via the sense line 516, to receive signals including location signals from other exit devices and/or to transmit the location signal from the location sensor 506 to other exit devices in the system in response to the flame signal. The controller 502 maybe further configured to transmit a status signal, via the communication module 512 to other exit devices in the system in response to the emergency signal. The status signal maybe a safe-status or an unsafe-status.

The controller 502 maybe further configured to apply a control signal via the control line 520 to the display screen 510 to display a visual signal in response to the flame signal. The visual signal maybe a red-color arrow sign or a green color arrow sign depending on the fire signal.

The controller 502 maybe further configured to apply a control signal via the control line 518 to the speaker 508 to broadcast an audible signal in response to the fire signal. The audible signal maybe a voice speaking either come-toward or go-away, or other audible directional instructions.

The controller 502 maybe further configured to receive location signals from other exit devices via the communication module 512. A programming code, stored on the storage device of the controller 512, operates to determine at least one of a safe pathway and an unsafe pathway. In particular, the safe pathway is a pathway which does not include any exit device that has transmitted a location signal in response to the fire m vicinity of its location, and the unsafe pathway is a pathway which includes at least one exit device that has transmitted a location signal in response to the fire in vicinity of its location.

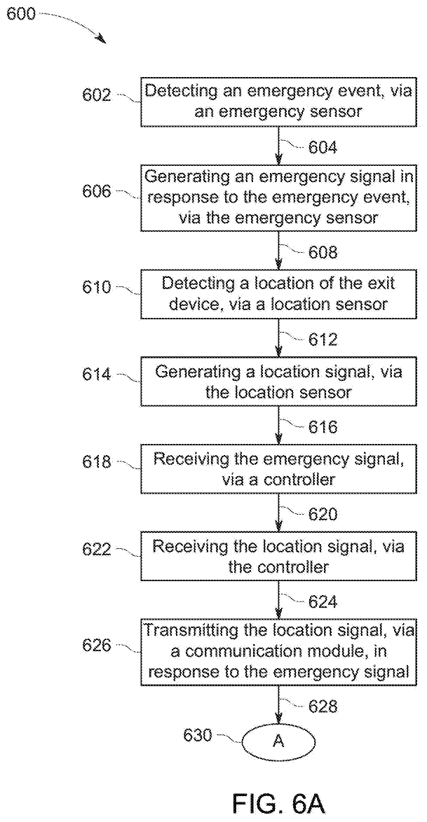

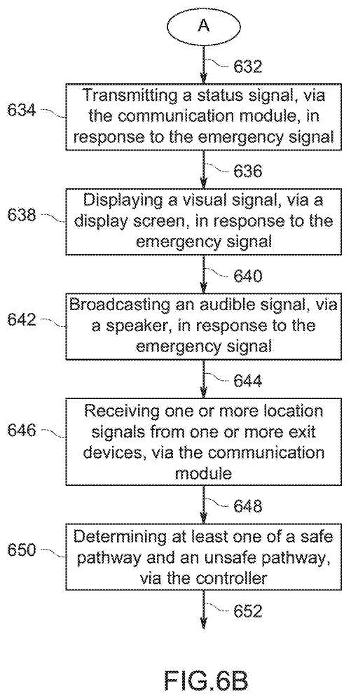

FIG. 6A is a flow diagram 600 of one preferred method of monitoring and communicating an emergency event, via an exit device such as the one depicted in FIG. 5. According to this embodiment, the method comprises detecting an emergency event, such as fire, via an emergency sensor such as the flame detector 504 at 602. Other triggered emergencies are also contemplated. The method further comprises generating an emergency signal in response to the emergency event, the emergency sensor at 606. The method further comprises detecting a location of the exit device, such as the exit device 500, via a location sensor such as the location sensor 506 at 610. The method further comprises generating a location signal, via the location sensor at 614. The method further comprises receiving the emergency signal, via a controller such as the controller 502 at 618. The method further comprises receiving the location signal, via the controller at 622. The method further comprises transmitting the location signal, via the communication module, in response to the emergency signal.

FIG. 6B is a flow diagram of one preferred method of monitoring and communicating an emergency event, via an exit device such as the one depicted in FIG. 5 that depicts additional steps that maybe added to the method of operation, depicted in FIG. 6A. According to this preferred embodiment of monitoring and communicating an emergency event, the method further comprises outputting additional warning signals and receiving location signals from other exit devices within the system to arrive at a safe pathway for the occupants to safely exit the building. Specifically, the method comprises transmitting a status signal, via the communication module, in response to the emergency signal at 634. The method further comprises displaying a visual signal, via a display screen such as the display screen 510 in response to the emergency signal at 638. The method further comprises broadcasting an audible signal, via a speaker such as the speaker 508 in response to the emergency signal at 642. The method further comprises receiving one or more location signals from one or more exit, devices, via the communication module at 646. The method further comprises determining at least one of a safe pathway and an unsafe pathway, via the controller at 650.

The foregoing explanations, descriptions, illustrations, examples, and discussions have been set forth to assist the reader with understanding this invention and further to demonstrate the utility and novelty of it and are by no means restrictive of the scope of the invention. It is the following claims, including all equivalents, which are intended to define the scope of this invention.

What is claimed is:

1. An emergency monitoring and communication system for a building, said building comprising a plurality of exit devices located throughout the building, wherein each of said plurality of exit devices is configured to ascertain an emergency event in vicinity of its location and to transmit a location signal in response to the emergency event.

2. The system of claim 1, wherein each of said plurality of exit devices is further configured to transmit a status signal in response to the emergency event.

3. The system of claim 2, wherein the status signal is one of safe-status and unsafe-status.

4. The system, of claim 1, wherein each of said plurality of exit devices is further configured to display a visual signal in response to the emergency event.

5. The system of claim 4, wherein the visual signal is one of red-color arrow sign and green-color arrow sign.

6. The system of claim 1, wherein each of said plurality of exit devices is further configured to broadcast an audible signal in response to the emergency event.

7. The system of claim 6, wherein the audible signal is a voice speaking one of come-toward and go-away.

8. The system of claim 1, wherein the emergency event is ascertained when at least one of flame, heat, carbon monoxide, and smoke is detected.

9. The system of claim 1, wherein each of said plurality of exit devices is further configured to store its location in its storage device.

10. The system of claim 1, wherein each of said plurality of exit devices is further configured to receive one or more location signals from one or more of said plurality of exit devices and to ascertain at least one of a safe pathway and an unsafe pathway.

11. The system of claim 10, wherein the safe pathway is a pathway which does not include any exit device that has transmitted a location signal in response to the emergency event in vicinity of its location and wherein the unsafe pathway is a pathway which includes at least one exit device that has transmitted a location signal in response to the emergency event in vicinity of its location.

12. The system of claim 10, further comprising a hand-held device, said hand-held device comprising an application program configured to display the at least one of a safe pathway and an unsafe pathway.

13. The system of claim 1, wherein said building further comprises two or more exit ports and wherein two or more of said plurality of exit devices are located in vicinity of the two or more exit ports.

14. An exit device, comprising:
an emergency sensor operative to detect an emergency event and to generate an emergency signal in response to the emergency event;
a location sensor operative to detect its location and to generate a location signal;
a communication module operative to at least one of receive and transmit radio waves; and
a controller, including a processing unit and program code stored on a storage device of said controller, said controller is coupled with the emergency sensor, the location sensor, and the communication module;
wherein the controller is configured to receive the emergency signal, via the emergency sensor, the location signal, via the location sensor, and to transmit the location signal, via the communication module, in response to the emergency signal.

15. The exit device of claim 14, wherein the controller is further configured to transmit a status signal, via the communication module, in response to the emergency signal.

16. The exit device of claim 15, wherein the status signal is one of safe-status and unsafe-status.

17. The exit device of claim 14, further comprising a display screen coupled with the controller, wherein the controller is further configured to display a visual signal, via the display screen, in response to the emergency signal.

18. The exit device of claim 17, wherein the visual signal is one of red-color arrow sign and green-color arrow sign.

19. The exit device of claim 14, further comprising a speaker coupled with the controller, wherein the controller is further configured to broadcast an audible signal, via the speaker, in response to the emergency signal.

20. The exit device of claim 19, wherein the audible signal is a voice speaking one of come-toward and go-away.

21. The exit device of claim 14, wherein the emergency sensor is one of a flame detector, a heat detector, a carbon monoxide detector, and a smoke detector.

22. The exit device of claim 14, wherein the controller is further configured to receive one or more location signals from one or more exit devices, via the communication module, and to determine at least one of a safe pathway and an unsafe pathway.

23. The exit device of claim 22, wherein the safe pathway is a pathway which does not include any exit device that has transmitted a location signal in response to the emergency event in vicinity of its location and wherein the unsafe pathway is a pathway which includes at least one exit device that has transmitted a location signal in response to the emergency event in vicinity of its location.

24. A method of monitoring and communicating an emergency event, via an exit device, said exit device comprising an emergency sensor, a location sensor, a communication module, and a controller, said method comprising:
(a) detecting the emergency event, via the emergency sensor;
(b) generating an emergency signal in response to the emergency event, via the emergency sensor;
(c) detecting a location of the exit device, via the location sensor;
(d) generating a location signal, via the location sensor;
(e) receiving the emergency signal, via the controller;
receiving the location signal, via the controller; and
(g) transmitting the location signal, via the communication module, in response to the emergency signal.

25. The method of claim 24, further comprising:
(h) transmitting a status signal, via the communication module, in response to the emergency signal.

30. The method of claim 24, wherein the exit device further comprises a display screen, said method further comprising:
(h) displaying a visual signal, via the display screen, in response to the emergency signal.

31. The method of claim 24, wherein the exit device further comprises a speaker, said method further comprising:
(h) broadcasting an audible signal, via the speaker, in response to the emergency signal.

32. The method of claim 24, further comprising:
(h) receiving one or more location signals from one or more exit devices, via the communication module; and
(i) determining at least one of a safe pathway and an unsafe pathway, via the controller.
